(19) United States
(12) Patent Application Publication
(10) Pub. No.: US 2026/0278174 A1
(43) Pub. Date: Sep. 17, 2026

(54) INFORMATION PROCESSING APPARATUS, INFORMATION PROCESSING METHOD AND NON-TRANSITORY COMPUTER READABLE MEDIUM

(71) Applicant: CANON KABUSHIKI KAISHA, Tokyo (JP)

(72) Inventor: RYO AKAMATSU, Tokyo (JP)

(21) Appl. No.: 19/554,856

(22) Filed: Mar. 3, 2026

(30) Foreign Application Priority Data
Mar. 11, 2025 (JP) 2025-038251

(51) Int. Cl. G06F 21/64; G06T 1/60; H04L 9/32; H04N 23/667

(52) U.S. Cl. CPC G06F 21/64; G06T 1/60; H04L 9/3236; H04N 23/667

(57) ABSTRACT

An information processing apparatus includes: a processor; and a memory storing a program which, when executed by the processor, causes the information processing apparatus to: generate a moving image file which includes a first area storing therein captured moving image data, and a second area storing therein management information for managing the moving image data; and set any one of a first shooting mode, in which the moving image file is generated without adding information for proving authenticity of the moving image file, and a second shooting mode, in which the moving image file is generated by adding the information for proving the authenticity of the moving image file to the moving image file, wherein arrangement of the first area and the second area in the moving image file is changed based on the shooting mode.

### BACKGROUND

### Field of the Technology

The present disclosure relates to an information processing apparatus, an information processing method and a non-transitory computer readable medium.

### Description of the Related Art

In recent years, information sharing via the Internet has been actively performed, and a user can disclose and transmit various pieces of information to an unspecified number of people. Furthermore, the user can perform various types of processing on a digital image. Information shared on the Internet may be transmitted from an unreliable source or may be falsified illegally. “C2PA Technical Specification” (Coalition for Content Provenance and Authenticity (C2PA), <Technical Specifications Version 1.2>, [online], November 2, 2022, [searched on Jan. 23, 2023], Internet <URL: https://c2pa.org/specifications/specifications/1.2/specs/C2PA_Specification.html>) proposes to calculate hash values of image and moving image files and record the hash values in a signing area in the files, in order to prove authenticity of the image and moving image files by verifying a source and history of images and moving images.

As a mechanism for detecting falsification of a digital image, it is possible to use a value obtained by hashing data in a file. A hash value calculated at the time of shooting the data whose falsification is desired to be detected is stored in an area protected by a signature. At the time of verification, a hash value is calculated from data to be verified. The hash value calculated from the data to be verified is compared with the hash value stored in the area protected by the signature. It is possible to verify that the data is not falsified by confirming matching between the hash value at the time of verification and the hash value at the time of shooting.

One method used for falsification detection is a method of calculating one hash value from a moving image file. In a case in which one hash value is calculated from a moving image file, it is desirable that the moving image file be configured to record an area for storing management information used to reproduce and decode a moving image after an area for storing moving image data. Since the hash value is calculated in the order in which the data is recorded, in a case in which the management information updated after recording of the moving image data is stored first, the hash value is calculated after recording of the moving image file including the moving image data and the management information is completed. On the other hand, in a case in which the moving image data is stored first, calculation of the hash value can be started without waiting for completion of recording of the moving image file.

However, in a case in which falsification detection is not performed, there is a case in which the area for storing the management information is recorded before the area for storing the moving image data in consideration of convenience at the time of reproduction and editing. A conventional device on the premise that the management information is stored first does not support reproduction and editing of a moving image file in which the management information is stored in an area after the moving image data.

### SUMMARY

The present disclosure provides an information processing apparatus capable of efficiently acquiring information for proving authenticity while suppressing an influence on reproduction and editing processing in a conventional device.

An information processing apparatus according to the present disclosure includes: a processor; and a memory storing a program which, when executed by the processor, causes the information processing apparatus to: execute generation processing of generating a moving image file which includes a first area storing therein captured moving image data, and a second area storing therein management information for managing the moving image data; and execute setting processing of setting any one of a first shooting mode, in which the moving image file is generated without adding information for proving authenticity of the moving image file, and a second shooting mode, in which the moving image file is generated by adding the information for proving the authenticity of the moving image file to the moving image file, wherein, in the generation processing, arrangement of the first area and the second area in the moving image file is changed based on the shooting mode set in the setting processing.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an information processing apparatus.

FIG. 2 is a diagram for description of a configuration of a box of MP4.

FIG. 3 is a diagram for description of a configuration of an MP4 file.

FIG. 4 is a diagram illustrating a configuration of a manifest store box.

FIG. 5 is a diagram illustrating a setting UI of a shooting mode according to a first embodiment.

FIG. 6 is a flowchart illustrating moving image file generation processing according to the first embodiment.

FIG. 7 is a flowchart illustrating details of processing in a first shooting mode.

FIGS. 8A-8E are schematic diagrams illustrating a configuration of a moving image file generated in the first shooting mode.

FIG. 9 is a flowchart illustrating processing in a second shooting mode.

FIGS. 10A-10E are schematic diagrams illustrating a configuration of a moving image file generated in the second shooting mode.

FIG. 11 is a diagram illustrating a setting UI of a shooting mode according to a second embodiment.

FIG. 12 is a flowchart illustrating moving image file generation processing according to the second embodiment.

FIG. 13 is a schematic diagram illustrating a configuration of a moving image file generated in a third shooting mode.

### DESCRIPTION OF THE EMBODIMENTS

Hereinafter, embodiments of the present disclosure will be described with reference to the drawings. However, configurations described in the respective embodiments are merely examples, and the scope of the present disclosure is not limited to the configurations described in the respective embodiments.

### First Embodiment

### System Configuration

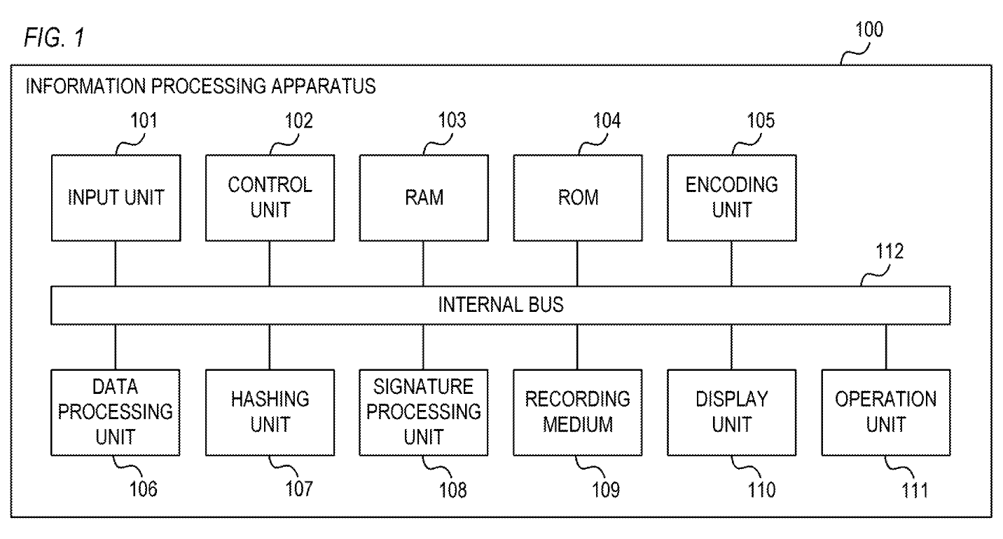

FIG. 1 is a block diagram illustrating a configuration of an information processing apparatus 100. The information processing apparatus 100 includes an input unit 101, a control unit 102, a random access memory (RAM) 103, and a read only memory (ROM) 104. Furthermore, the information processing apparatus 100 includes an encoding unit 105, a data processing unit 106, a hashing unit 107, a signature processing unit 108, a recording medium 109, a display unit 110, an operation unit 111, and an internal bus 112.

The input unit 101 acquires moving image data (including image data and audio data) input from outside of the information processing apparatus 100. The input unit 101 may include an imaging unit and a microphone, and may acquire a moving image shot by the imaging unit and sound collected by the microphone as moving image data.

The control unit 102 controls each unit of the information processing apparatus 100 in response to an input signal and a program. Note that the control unit 102 may control the entire device by a plurality of pieces of hardware sharing processing instead of controlling the entire device by a program. The RAM 103 is used as a buffer memory for temporarily storing various types of data and a work area of the control unit 102. The ROM 104 stores a program executed by the control unit 102 and data referred to by the control unit 102.

The control unit 102, the RAM 103, and the ROM 104 are used to implement processing by other functional units. The control unit 102 loads a program stored in the ROM 104 and the recording medium 109 into the RAM 103 and executes the program, thereby controlling each functional unit and implementing processing by each functional unit.

The encoding unit 105 compresses an information amount of each piece of data by encoding the image data and the audio data input to the input unit 101 according to a known encoding system such as H.264 (MPEG4 AVC). The encoding unit 105 also performs processing for recording image data and audio data.

The data processing unit 106 generates various types of management information defined by the MP4 file. In a case of generating a moving image file to which information for proving authenticity of the moving image file is added, the data processing unit 106 also generates various types of management information defined by C2PA.

The hashing unit 107 uses the image data and the audio data encoded by the encoding unit 105, the management information of each piece of data, and the like as inputs, and calculates a hash value according to a known hash algorithm such as SHA-256. The hashing unit 107 may intermittently receive data for calculating the hash value, and holds the received data as data for acquiring the hash value. The hashing unit 107 can sequentially advance the calculation of the hash value using the held acquisition data. The signature processing unit 108 encrypts the input data according to a known encryption algorithm such as RSA encryption.

The recording medium 109 records various types of data. The recording medium 109 may be detachable from the information processing apparatus 100 or may be incorporated in the information processing apparatus 100. The display unit 110 is, for example, a liquid crystal display. The display unit 110 displays an input or reproduced moving image and displays various types of information such as a menu screen.

The operation unit 111 is used to receive an instruction to the information processing apparatus 100 from a user. The operation unit 111 includes a power button for the user to instruct power on/off of the information processing apparatus 100, a moving image shooting start button for starting shooting of a moving image, a button for selecting a menu displayed on the display unit 110, and the like. The internal bus 112 is a communication path for transmitting and receiving signals between respective blocks included in the information processing apparatus 100.

### Configuration of Box

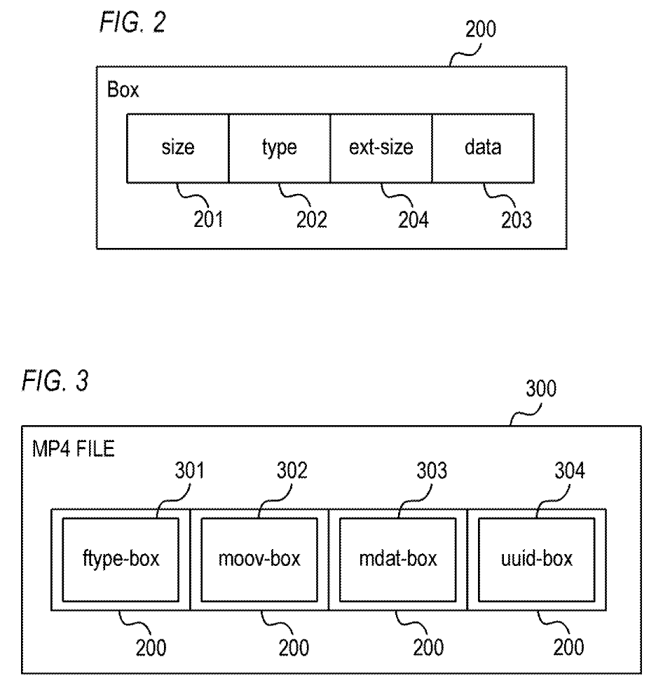

With reference to FIG. 2, the configuration of a box 200 of MP4 in the format of a moving image file will be described. Moving image data can be recorded according to the MP4 file format. The MP4 file is configured by a unit called a box.

FIG. 2 illustrates the configuration of the box 200. One box 200 includes areas of a size 201, a type 202, and data 203. The size 201 stores information (hereinafter, also described as size information) of a data length (byte) of the box 200. The type 202 stores information indicating a type of data stored in the data 203. The data 203 stores actual data.

The type 202 is a 32 bit fixed-length data area. The data 203 is a variable length area. Since the size 201 is a 32 bit fixed-length data area, the size of one box is usually 0xFFFFFFFF bytes or less. Depending on the box type, the size of one box may exceed 32 bits. The box 200 has an ext-size 204 (extended box size) in a case in which the size of one box exceeds a size that can be represented by 32 bits. The ext-size 204 stores size information of a portion exceeding 0xFFFFFFFF bytes of the data length (bytes) of the box 200.

FIG. 3 is a diagram illustrating a configuration of an MP4 file 300. The MP4 file 300 includes a plurality of boxes 200. The MP4 file 300 includes four storage units (boxes) of an ftype-box 301, a moov-box 302, an mdat-box 303, and a uuid-box 304. An authenticity-guaranteed MP4 file to which information for proving authenticity is added includes at least four boxes illustrated in FIG. 3. On the other hand, an MP4 file that does not require authenticity guarantee and to which the information for proving authenticity is not added may include at least three boxes including the ftype-box 301, the moov-box 302, and the mdat-box 303 among the four boxes illustrated in FIG. 3.

The ftype-box 301 is a FileType box whose type 202 is “ftype”. The ftype-box 301 is used to store information on file compatibility. The information processing apparatus 100 can determine, based on the information described in the data 203 of the ftype-box 301, an encoding system or the like of the moving image data (image data and audio data) stored in the MP4 file.

The moov-box 302 is a Movie box whose type 202 is “moov”. The moov-box 302 is used to store management information for managing moving image data (image data and audio data). The data 203 of the moov-box 302 stores information regarding chunks of the image data and the audio data stored in the mdat-box 303. The chunk is a unit including a predetermined data amount, and includes a plurality of samples. The information regarding the chunk stored in the data 203 of the moov-box 302 includes information such as a chunk offset indicating an offset of each chunk from a head of the file, the number of samples of each chunk, and the sample size of each sample.

The mdat-box 303 is a MediaDataFileType box whose type 202 is “mdat”. The mdat-box 303 is used to store each sample of captured moving image data (image data and audio data). The encoded image data and audio data are divided into units of chunks each including a plurality of samples and are stored in the mdat-box 303. One chunk of the image data can be, for example, moving image data of 1GOP defined by the H.264 format. Furthermore, one chunk of the audio data can be audio data of the number of frames corresponding to one GOP of the image data. The mdat-box 303 can have the ext-size 204 described in FIG. 2.

The uuid-box 304 is a Uuid box whose type 202 is “uuid”. The uuid-box 304 is used to store data uniquely defined by the user. In the format defined by C2PA, the uuid-box 304 can store information regarding the source and the history of the moving image file. The information regarding the source and the history of the moving image file is information for proving authenticity of the moving image file. Hereinafter, the information for proving the authenticity of the moving image file is also described as authenticity information. The uuid box that stores the authenticity information is hereinafter described as a manifest store box.

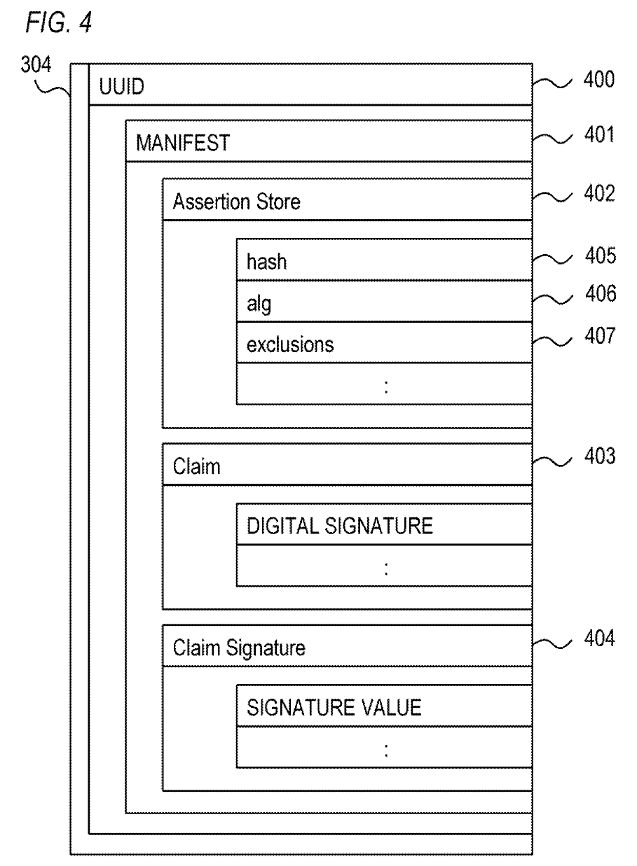

FIG. 4 is a diagram illustrating a configuration of the manifest store box. A manifest store box 400 stores manifest 401 including authenticity information. The manifest 401 includes AssertionStore 402, Claim 403, and ClaimSignature 404.

The AssertionStore 402 includes hash 405, alg 406, and exclusions 407, and stores information used to prove authenticity of a content. The hash 405 stores a hash value of falsification detection target data. The alg 406 stores information of an algorithm used to calculate the hash value stored in the hash 405.

When the hash value is calculated, the exclusions 407 stores information of an area to be excluded from calculation of the hash value among the data of the falsification detection target. The exclusions 407 can store information of the entire box and information of a partial area in the box as areas to be excluded from calculation of the hash value.

The Claim 403 includes an area for storing a digital signature and the like, and stores data used for a digital signature. The ClaimSignature 404 stores data such as a signature value encrypted or signed by the signature processing unit 108.

The manifest store box of FIG. 4 illustrates a configuration example of a box based on a format defined by C2PA, but may include a box and a field (not illustrated). In addition, as long as the information described in FIG. 4 can be stored, the configuration itself, the box type, the name, and the like in the box may be different from those in the example illustrated in FIG. 4.

As described with reference to FIGS. 2-4, the MP4 file 300 includes a plurality of boxes. In addition, respective sizes of the moov box 302 and the mdat box 303 vary depending on the number of image (moving image) and audio sample data, that is, a recording time, and data amounts of the compressed image data and audio data.

### Setting of Shooting Mode

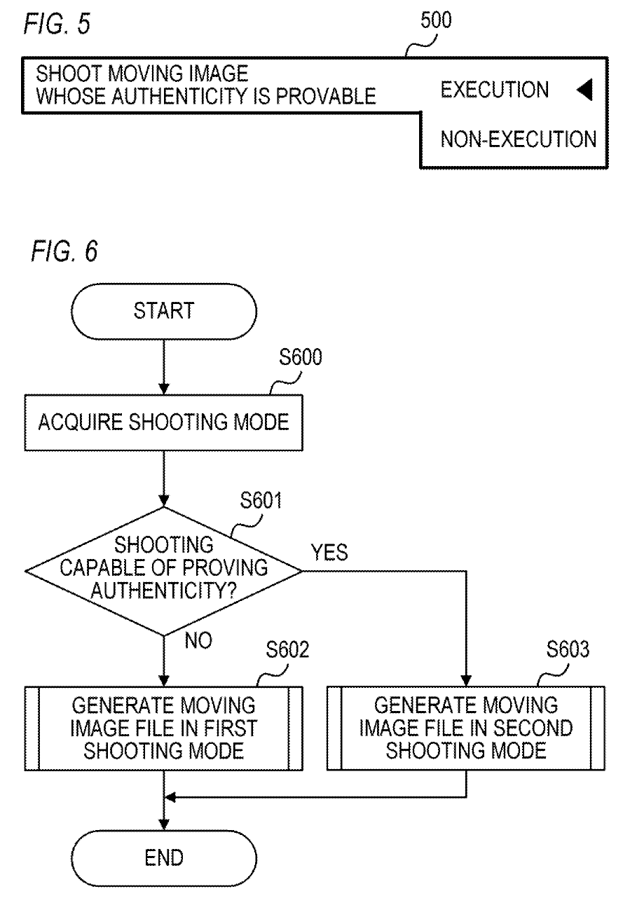

A setting user interface (UI) of the shooting mode in a first embodiment will be described with reference to FIG. 5. The information processing apparatus 100 can display a setting UI 500 illustrated in FIG. 5 on the display unit 110 as a menu screen. The user sets, by the operation unit 111, whether to perform shooting of a moving image, the authenticity of which is provable.

In a case in which the user selects a shooting mode in which shooting is performed for a moving image, the authenticity of which does not need to be proved (hereinafter, described as a first shooting mode), the control unit 102 sets the shooting mode to the first shooting mode and generates a moving image file, the authenticity of which is not guaranteed. In a case in which the user selects a shooting mode in which shooting is performed for a moving image, the authenticity of which is provable (hereinafter, described as a second shooting mode), the control unit 102 sets the shooting mode to the second shooting mode and generates a moving image file, the authenticity of which is guaranteeable. The set shooting mode is recorded in the RAM 103 or the ROM 104.

FIG. 5 illustrates an example in which the setting UI 500 is displayed on the display unit 110 and is selected by the user. However, the user may be able to set whether to perform shooting of a moving image, the authenticity of which is provable, by another method. For example, the user may be able to set whether to perform shooting of a moving image, the authenticity of which is provable, by using a button provided to shoot a moving image, the authenticity of which is guaranteeable, and a button provided to shoot a moving image, the authenticity of which does not need to be proved.

### Generation of Moving Image File

FIG. 6 is a flowchart illustrating moving image file generation processing according to the first embodiment. The moving image file generation processing illustrated in FIG. 6 is started when the user starts recording a moving image by the information processing apparatus 100.

In step S600, the control unit 102 acquires the current shooting mode. The current shooting mode is, for example, a shooting mode selected by the setting UI 500 illustrated in FIG. 5, and is recorded in the RAM 103 or the ROM 104.

In step S601, the control unit 102 determines whether the current shooting mode acquired in step S600 is a shooting mode (the second shooting mode) in which shooting is performed for a moving image, the authenticity of which is provable. In a case in which the control unit 102 determines that the current shooting mode is a shooting mode (the first shooting mode) in which shooting is performed for a moving image, the authenticity of which does not need to be proved, the processing proceeds to step S602. In a case in which the control unit 102 determines that the current shooting mode is a shooting mode (the second shooting mode) in which shooting is performed for a moving image, the authenticity of which is provable, the processing proceeds to step S603.

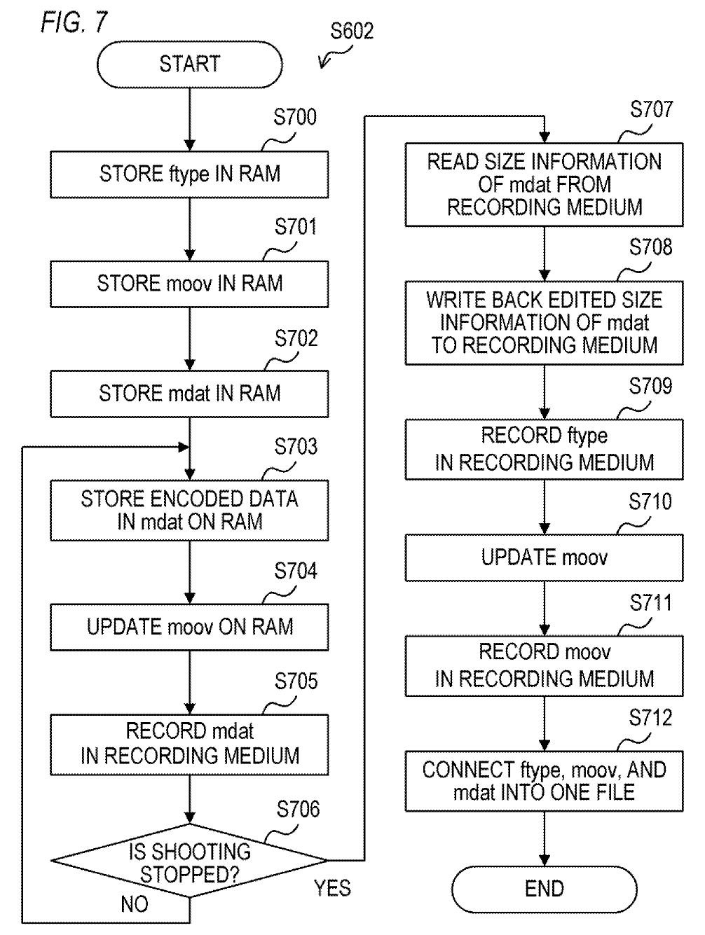

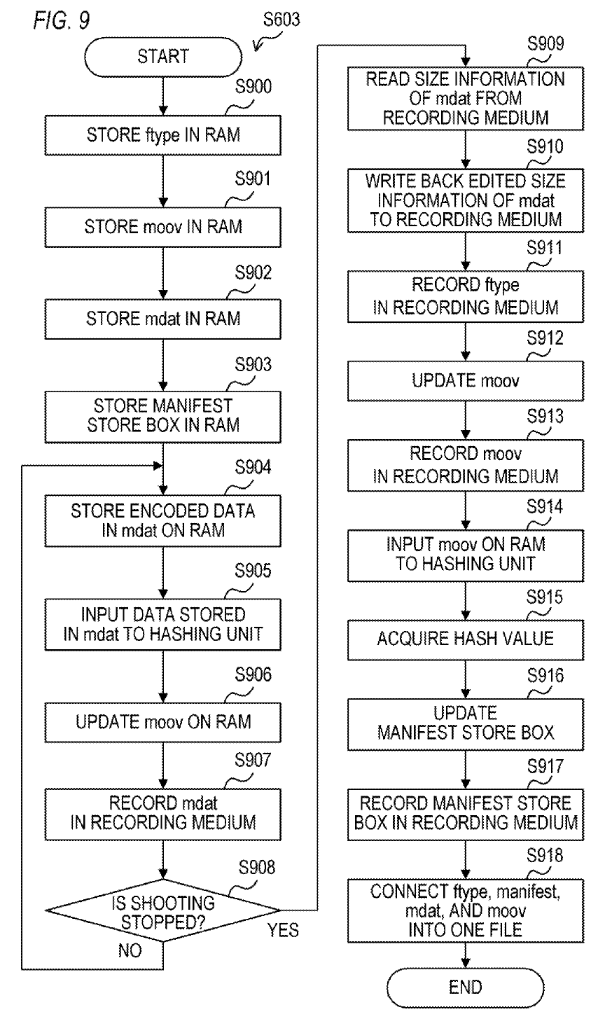

In step S602, the control unit 102 generates a moving image file in the first shooting mode. Details of moving image file generation processing in the first shooting mode will be described with reference to FIG. 7. In step S603, the control unit 102 generates a moving image file in the second shooting mode. Details of moving image file generation processing in the second shooting mode will be described with reference to FIG. 9.

### Generation of Moving Image File in First Shooting Mode

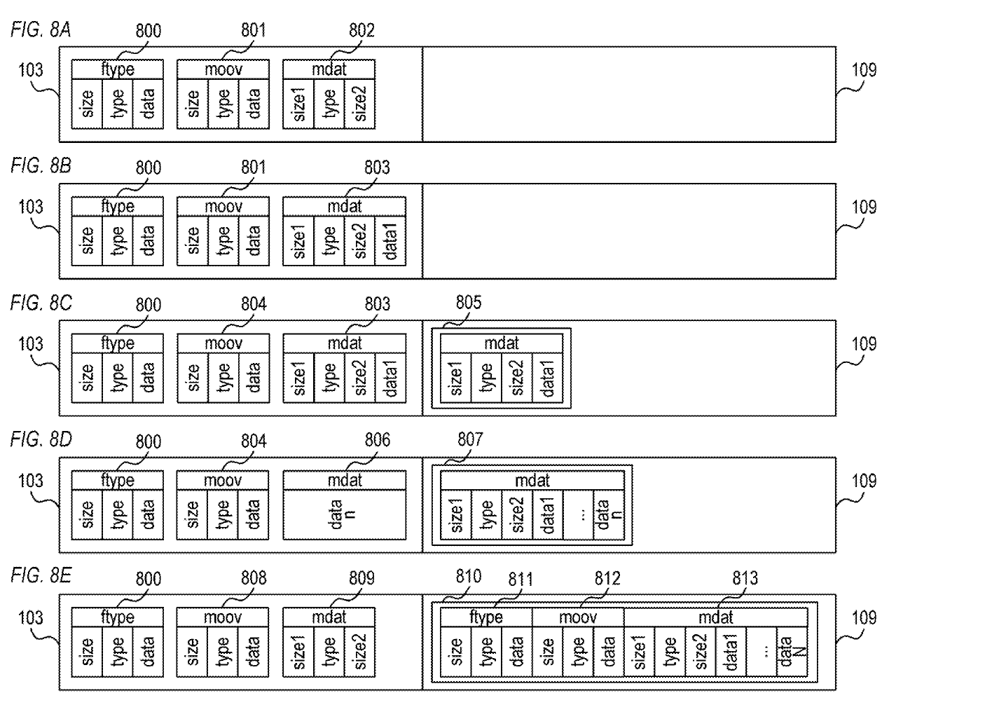

Generation of a moving image file in the first shooting mode will be described with reference to FIGS. 7 and 8A-8E. The first shooting mode is a shooting mode in which a moving image file is generated without adding information for proving authenticity of the moving image file. FIG. 7 is a flowchart illustrating the moving image file generation processing in the first shooting mode. FIG. 7 illustrates details of the processing in step S602 of FIG. 6 (moving image file generation processing not supporting authenticity guarantee). FIGS. 8A-8E are schematic diagrams illustrating a configuration of the moving image file generated in the first shooting mode. FIGS. 8A-8E illustrate a configuration of data generated on the RAM 103 and a configuration of data recorded in the recording medium 109.

In step S700, the control unit 102 instructs the data processing unit 106 to generate the ftype box (the ftype-box 301). The data processing unit 106 generates an ftype box 800 and stores the generated ftype box 800 in the RAM 103 (memory).

In step S701, the control unit 102 instructs the data processing unit 106 to generate the moov box (the moov-box 302). The data processing unit 106 generates a moov box 801 and stores the generated moov box 801 in the RAM 103.

In step S702, the control unit 102 instructs the data processing unit 106 to generate the mdat box (the mdat-box 303). The data processing unit 106 generates an mdat box 802 and stores the generated mdat box 802 in the RAM 103. FIG. 8A illustrates states of the RAM 103 and the recording medium 109 after the processing in steps S700 to S702 is completed.

In step S703, the control unit 102 instructs the encoding unit 105 to encode the moving image data input from the input unit 101. The control unit 102 generates an mdat box 803 on the RAM 103, and stores the data (hereinafter, also described as encoded data) encoded by the encoding unit 105 in the mdat box 803.

The processing in step S703 is executed for each predetermined data amount of the moving image data during the shooting of the moving image. The mdat box 803 generated in first encoding processing for a moving image file to be generated includes size information (size1, size2), a data type (type), and encoded data (data1). FIG. 8B illustrates the states of the RAM 103 and the recording medium 109 after the first encoding processing. In the second and subsequent encoding processing, the control unit 102 generates an mdat box 806 (refer to FIG. 8D) including only the encoded data.

In step S704, the control unit 102 instructs the data processing unit 106 to update the moov box on the RAM 103. The data processing unit 106 updates contents of a moov box 804 on the RAM 103. For example, the data processing unit 106 adds the management information of the data stored in the mdat box 803 in step S703 to the moov box 804.

In step S705, the control unit 102 records the mdat box 803 on the RAM 103 in the recording medium 109. In first writing for the moving image file to be generated, the control unit 102 writes an mdat box 805 including the size information (size1, size2) and the information of the data type (type) in addition to the moving image data (data1) in the recording medium 109. FIG. 8C illustrates the states of the RAM 103 and the recording medium 109 after the first writing to the recording medium 109 is completed.

In second and subsequent writings, the control unit 102 adds the data of the mdat box 806 including only the encoded data to an existing mdat box 807 on the recording medium 109. FIG. 8D illustrates the states of the RAM 103 and the recording medium 109 after the second and subsequent writings are completed. The data of the mdat box 806 stored in the RAM 103 is added to the mdat box 807 recorded in the recording medium 109.

In step S706, the control unit 102 determines whether shooting of the moving image is stopped. In a case in which the control unit 102 determines that the shooting of the moving image is stopped, the processing proceeds to step S707. In a case in which the control unit 102 determines that the shooting of the moving image is not stopped, the processing returns to step S703.

In step S707, the control unit 102 reads size information (size1, size2) of the mdat box 807 from the recording medium 109 and loads the size information into the RAM 103. Since the size of the mdat box is information determined after the recording of the moving image is completed, the size of the mdat box is updated, for example, at a timing of recording data in the recording medium 109.

In step S708, the control unit 102 instructs the data processing unit 106 to update size information of an mdat box 809 read on the RAM 103 in step S707. The data processing unit 106 updates the size information of the mdat box 809 stored in the RAM 103. For example, the data processing unit 106 can update the size information of the mdat box 809 based on the size of the data recorded in the recording medium 109 in step S705. The control unit 102 writes the size information of the mdat box 809 updated in step S708 back to the recording medium 109.

In step S709, the control unit 102 records the information of the ftype box 800 stored in the RAM 103 in the recording medium 109. In step S710, the control unit 102 instructs the data processing unit 106 to update a moov box 808. The data processing unit 106 updates information of the moov box 808 stored in the RAM 103. In step S711, the control unit 102 records the information of the updated moov box 808 on the RAM 103 in the recording medium 109.

In step S712, the control unit 102 generates one moving image file 810 by connecting boxes recorded in the recording medium 109 in the order of an ftype box 811, a moov box 812, and an mdat box 813. FIG. 8E illustrates the states of the RAM 103 and the recording medium 109 after the processing in steps S700 to S712 is completed.

The control unit 102 can generate the moving image file 810 by the processing described with reference to FIG. 7. The moving image file 810 includes the ftype box 811, the moov box 812, and the mdat box 813 in this order from the head of the file. Since this configuration can be reproduced by a conventional device, the moving image file generated by the processing illustrated in FIG. 7 can be reproduced and edited by the conventional device without changing software. Note that the generated moving image file is not limited to one mdat box, and may include a plurality of mdat boxes.

### Generation of Moving Image File in Second Shooting Mode

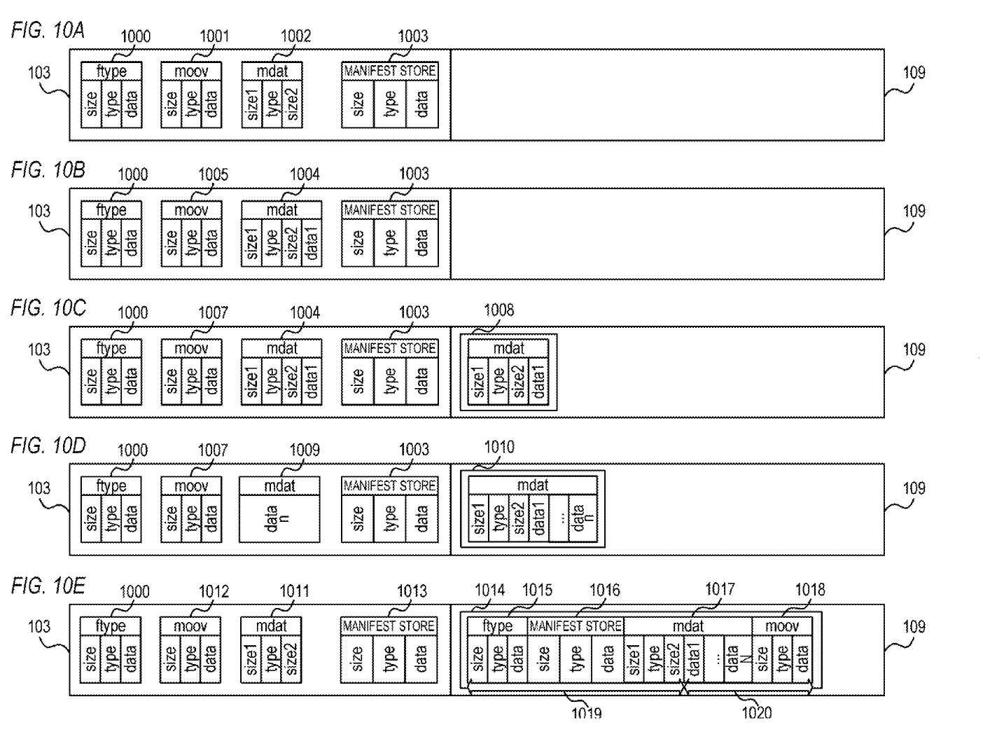

Generation of a moving image file in the second shooting mode will be described with reference to FIGS. 9 and 10A-10E. The second shooting mode is a shooting mode in which a moving image file is generated by adding information for proving authenticity of the moving image file. FIG. 9 is a flowchart illustrating the moving image file generation processing in the second shooting mode. FIG. 9 illustrates details of the processing in step S603 of FIG. 6 (moving image file generation processing that supports authenticity guarantee). FIGS. 10A-10E are schematic diagrams illustrating a configuration of the moving image file generated in the second shooting mode. FIGS. 10A-10E illustrate a configuration of data generated on the RAM 103 and a configuration of data recorded on the recording medium 109.

In step S900, the control unit 102 instructs the data processing unit 106 to generate the ftype box (the ftype-box 301). The data processing unit 106 generates an ftype box 1000 and stores the generated ftype box 1000 in the RAM 103 (memory).

In step S901, the control unit 102 instructs the data processing unit 106 to generate the moov box (the moov-box 302). The data processing unit 106 generates a moov box 1001 and stores the generated moov box 1001 in the RAM 103.

In step S902, the control unit 102 instructs the data processing unit 106 to generate the mdat box (the mdat-box 303). The data processing unit 106 generates an mdat box 1002 and stores the generated mdat box 1002 in the RAM 103.

In step S903, the control unit 102 instructs the data processing unit 106 to generate a manifest store box. The data processing unit 106 generates a manifest store box 1003 and stores the generated manifest store box 1003 in the RAM 103. FIG. 10A illustrates the states of the RAM 103 and the recording medium 109 after the processing in steps S900 to S903 is completed.

In step S904, the control unit 102 instructs the encoding unit 105 to encode the moving image data input from the input unit 101. The control unit 102 generates an mdat box 1004 on the RAM 103, and stores the data encoded by the encoding unit 105 in the mdat box 1004.

The processing in step S904 is executed for each predetermined data amount of the moving image data during the shooting of the moving image. The mdat box 1004 generated in first encoding processing for a moving image file to be generated includes size information (size1, size2), a data type (type), and encoded data (data1). FIG. 10B illustrates the states of the RAM 103 and the recording medium 109 after the first encoding processing. In the second and subsequent encoding processing, the control unit 102 generates an mdat box 1009 (refer to FIG. 10D) including only the encoded data.

In step S905, the control unit 102 inputs the encoded data stored in the mdat box on the RAM 103 in step S904 to the hashing unit 107. The hashing unit 107 holds the input encoded data as acquisition data used to acquire a hash value for the moving image file. The hashing unit 107 acquires encoded data for each predetermined data amount of the moving image file and adds the encoded data to the acquisition data until shooting is stopped. In a case in which the mdat box includes the size information of the mdat box, the control unit 102 sets an area including the size information as an area not to be hashed, and does not input the data of the size information to the hashing unit 107. That is, the control unit 102 acquires a hash value by removing the information regarding the size of the moving image data from the moving image data.

In step S906, the control unit 102 instructs the data processing unit 106 to update the moov box on the RAM 103. The data processing unit 106 updates the contents of a moov box 1007 on the RAM 103. For example, the data processing unit 106 adds the management information of the data stored in the mdat box 1004 in step S904 to the moov box 1007.

In step S907, the control unit 102 records the mdat box 1004 on the RAM 103 in the recording medium 109. In first writing for the moving image file to be generated, the control unit 102 writes an mdat box 1008 including the size information (size1, size2) and the information of the data type (type) in addition to the moving image data (data1) in the recording medium 109. FIG. 10C illustrates the states of the RAM 103 and the recording medium 109 after the first writing to the recording medium 109 is completed.

In second and subsequent writings, the control unit 102 adds the data of the mdat box 1009 including only the encoded data to an mdat box 1010 on the recording medium 109. FIG. 10D illustrates the states of the RAM 103 and the recording medium 109 after the second and subsequent writings are completed. The data of the mdat box 1009 stored in the RAM 103 is added to the mdat box 1010 recorded in the recording medium 109.

In step S908, the control unit 102 determines whether shooting of the moving image is stopped. In a case in which the control unit 102 determines that the shooting of the moving image is stopped, the processing proceeds to step S909. In a case in which the control unit 102 determines that the shooting of the moving image is not stopped, the processing returns to step S904.

In step S909, the control unit 102 reads size information (size1, size2) of the mdat box 1010 from the recording medium 109 and loads the size information into the RAM 103. Since the size of the mdat box is information determined after shooting of the moving image is completed, the size of the mdat box is updated, for example, at a timing of recording data in the recording medium 109.

In step S910, the control unit 102 instructs the data processing unit 106 to update size information of an mdat box 1011 read on the RAM 103 in step S909. The data processing unit 106 updates the size information of the mdat box 1011 stored in the RAM 103. For example, the data processing unit 106 can update the size information of the mdat box 1011 based on the size of the data recorded in the recording medium 109 in step S907. The control unit 102 writes the size information of the mdat box 1011 updated in step S910 back to the recording medium 109.

In step S911, the control unit 102 records the information of the ftype box 1000 stored in the RAM 103 in the recording medium 109. In step S912, the control unit 102 instructs the data processing unit 106 to update a moov box 1012. The data processing unit 106 updates information of the moov box 1012 stored in the RAM 103. In step S913, the control unit 102 records the information of the updated moov box 1012 on the RAM 103 in the recording medium 109.

In step S914, the control unit 102 inputs data of the moov box 1012 on the RAM 103 to the hashing unit 107. In step S905, the hashing unit 107 adds the data of the moov box 1012 (management information) to the encoded data (acquisition data) input for each predetermined data amount of the moving image data.

In step S915, the control unit 102 instructs the hashing unit 107 to acquire a hash value for the moving image file. The hashing unit 107 acquires the hash value for the moving image file by using the acquisition data input to the hashing unit 107 in steps S905 and S914 and held by the hashing unit 107. The control unit 102 acquires the hash value as information for proving authenticity of the moving image file from the hashing unit 107. Note that the control unit 102 can sequentially calculate the hash values from the acquisition data input in step S905 without waiting for the data of the moov box 1012 to be input to the hashing unit 107 in step S914.

In step S916, the control unit 102 instructs the data processing unit 106 to update a manifest store box 1013. The data processing unit 106 updates the manifest store box 1013 on the RAM 103.

The data processing unit 106 stores the hash value acquired in step S915 in the hash 405 of the manifest store box 1013. As described above, the hash value, which is information for proving authenticity of the moving image file, is stored in an area of the manifest store box 1013 other than areas of the mdat box 1011 and the moov box 1012.

The data processing unit 106 stores an area in which the size information of the mdat box is recorded in the exclusions 407 as an area not to be hashed. The reason for this is that an area in which the information regarding the size of the mdat box is recorded in step S905 is not a hashing target. Furthermore, the signature processing unit 108 updates the manifest 401 including the Claim 403 and the ClaimSignature 404 on the RAM 103. In step S917, the control unit 102 records a manifest store box 1016 in the recording medium 109.

In step S918, the control unit 102 generates one moving image file 1014 by connecting the respective boxes recorded in the recording medium 109. The control unit 102 connects the respective boxes in the order of an ftype box 1015, the manifest store box 1016, an mdat box 1017, and a moov box 1018. FIG. 10E illustrates the states of the RAM 103 and the recording medium 109 after the processing in steps S900 to S918 is completed.

The control unit 102 can generate the moving image file 1014 by the processing described with reference to FIG. 9. The moving image file 1014 includes the ftype box 1015, the manifest store box 1016, the mdat box 1017, and the moov box 1018 in this order from the head of the file.

In the first shooting mode, the control unit 102 generates the moving image file 810 such that the moov box 812 (second area) is arranged before the mdat box 813 (first area). On the other hand, in the second shooting mode, the control unit 102 generates the moving image file 1014 such that the mdat box 1017 (first area) is arranged before the moov box 1018 (second area). In this manner, the control unit 102 (the data processing unit 106) changes, based on the set shooting mode, arrangement of the moov box and the mdat box in the moving image file. In the second shooting mode, by arranging the moov box after the mdat box, the control unit 102 can start calculation of the hash value during shooting of the moving image.

An area in a range indicated by an arrow 1019 in FIG. 10E is an area that is not a calculation target when the hash value of the moving image file 1014 is acquired. An area in a range indicated by an arrow 1020 in FIG. 10E is an area that is a calculation target when the hash value of the moving image file 1014 is acquired. The area in the range indicated by the arrow 1020 is input to the hashing unit 107 in order from the area on the mdat box 1017 side. The hashing unit 107 can calculate the hash value of the moving image file recorded in the manifest store box 1016 by sequentially processing the pieces of input data. Furthermore, by excluding an area in which the size information of the mdat box 1017 determined at the end of shooting is recorded from a calculation target for acquiring a hash value, the hashing unit 107 can calculate the hash value even during the shooting of the moving image.

According to the first embodiment described above, a moving image file generated in the first shooting mode in which shooting is performed for a moving image, the authenticity of which does not need to be proved, can be reproduced by a conventional device. On the other hand, in the moving image file generated in the second shooting mode in which shooting is performed for the moving image, the authenticity of which is provable, the moov box 1018 in which the content is confirmed after the shooting of the moving image is completed is finally arranged, and thus, the control unit 102 can calculate the hash value during the shooting of the moving image.

Note that, in a case in which a box not described in the first embodiment is additionally recorded, the box to be added may be recorded after the mdat box 1017 such that the order of the mdat box 1017 and the moov box 1018 is not changed. Alternatively, by describing the box to be added in the exclusions 407, the entire box may be excluded from the calculation target for acquiring the hash value.

### Second Embodiment

A second embodiment is an embodiment in a case in which the information processing apparatus 100 supports two calculation methods of a hash value used for detecting falsification of file data defined in C2PA. A configuration of the information processing apparatus 100 according to the second embodiment is similar to that of the first embodiment. Hereinafter, differences from the first embodiment will be mainly described.

### Setting of Shooting Mode

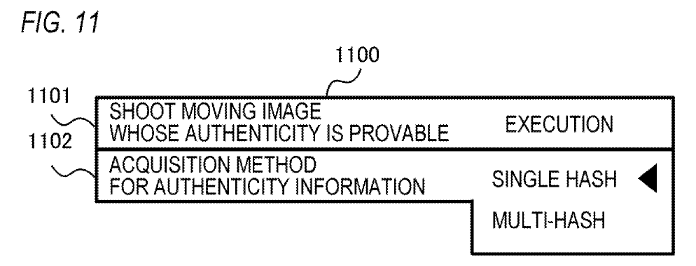

A setting user interface (UI) of the shooting mode in the second embodiment will be described with reference to FIG. 11. The information processing apparatus 100 can display a setting UI 1100 illustrated in FIG. 11 on the display unit 110 as a menu screen. A user sets, by the operation unit 111, whether to perform shooting of a moving image, the authenticity of which is provable in a setting item 1101. The set shooting mode is recorded in the RAM 103 or the ROM 104.

In a case in which the user makes a selection to “perform” shooting of a moving image, the authenticity of which is provable, the user can further select an acquisition method of information for proving the authenticity (authenticity information) in a setting item 1102. The selected acquisition method for authenticity information is recorded in the RAM 103 or the ROM 104. Information for proving authenticity of a moving image file is acquired by a different method according to the selected acquisition method for authenticity information. The acquisition method for authenticity information is defined in C2PA.

In the example of FIG. 11, the acquisition method for authenticity information, which is selectable in the setting item 1102, includes a single hash format and a multi-hash format. The single hash format is a format in which one hash value is generated and held for a moving image file. The multi-hash format is a format in which a hash value is generated for each predetermined data amount of the moving image file and a plurality of hash values are held. The predetermined data amount is, for example, a data amount of image data or audio data divided into units called chunks in the mdat box.

In the single hash format, the control unit 102 generates a moving image file that acquires and holds a hash value for the moving image file, similarly to the second shooting mode according to the first embodiment. In the multi-hash format, the control unit 102 acquires a hash for each predetermined data amount and generates a moving image file that holds the hashes. The control unit 102 changes arrangement of the mdat box (first area) and the moov box (second area) in the moving image file based on the selected acquisition method for authenticity information.

Note that the format for holding the hash value defined by C2PA is expressed as the single hash format and the multi-hash format, but if the two formats can be distinguished, the wording displayed on the setting item 1102 of the display unit 110 as an option is not limited to the example of FIG. 11.

### Generation of Moving Image File

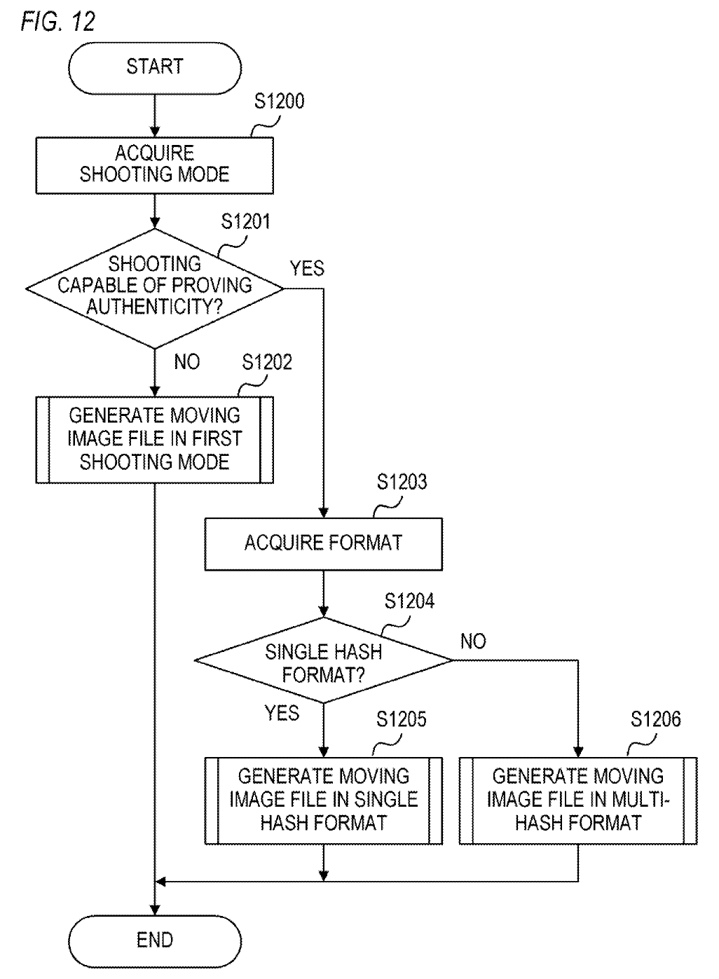

FIG. 12 is a flowchart illustrating moving image file generation processing according to the second embodiment. The moving image file generation processing illustrated in FIG. 12 is started when the user starts recording a moving image by the information processing apparatus 100.

In step S1200, the control unit 102 acquires the current shooting mode. The current shooting mode is, for example, a shooting mode selected by the setting UI 1100 illustrated in FIG. 11, and is recorded in the RAM 103 or the ROM 104.

In step S1201, the control unit 102 determines whether the current shooting mode acquired in step S1200 is a shooting mode (the second shooting mode) in which shooting is performed for a moving image, the authenticity of which is provable. In a case in which the control unit 102 determines that the current shooting mode is a shooting mode (the first shooting mode) in which shooting is performed for a moving image, the authenticity of which does not need to be proved, the processing proceeds to step S1202. In a case in which the control unit 102 determines that the current shooting mode is a shooting mode (the second shooting mode) in which shooting is performed for a moving image, the authenticity of which is provable, the processing proceeds to step S1203.

In step S1202, the control unit 102 generates a moving image file in the first shooting mode. Details of the moving image file generation processing in the first shooting mode are the same as the moving image file generation processing described with reference to FIG. 7 in the first embodiment, and thus the description thereof will be omitted.

In step S1203, the control unit 102 acquires the current acquisition method (format) for authenticity information. The current acquisition method for authenticity information is, for example, an acquisition method selected in the setting item 1102 illustrated in FIG. 11, and is recorded in the RAM 103 or the ROM 104.

In step S1204, the control unit 102 determines whether the acquisition method (format) for authenticity information, which is acquired in step S1203, is the single hash format. In a case in which the control unit 102 determines that the acquisition method for authenticity information is the single hash format, the processing proceeds to step S1205. In a case in which the control unit 102 determines that the acquisition method for authenticity information is not the single hash format, the processing proceeds to step S1206.

In step S1205, the control unit 102 generates a moving image file in the single hash format. In the single hash format, the control unit 102 generates the moving image file such that the mdat box (first area) is arranged before the moov box (second area). Since the details of the moving image file generation processing in the single hash format are the same as those of the moving image file generation processing described with reference to FIG. 9 in the first embodiment, the description thereof will be omitted.

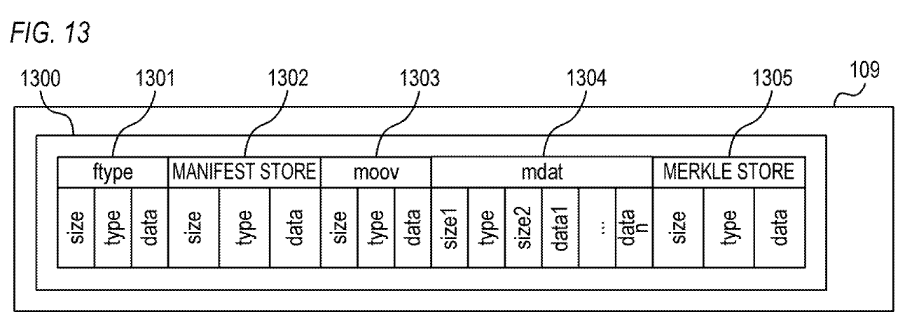

In step S1206, the control unit 102 generates a moving image file in the multi-hash format. In the multi-hash format, the control unit 102 generates the moving image file such that the moov box (second area) is arranged before the mdat box (first area). Details of the moving image file generation processing in the multi-hash format will be described below with reference to FIGS. 9 and 13.

### Generation of Moving Image File in Multi-Hash Format

Generation of a moving image file in the multi-hash format (also referred to as a Merkle tree format) will be described with reference to FIGS. 9 and 13. The moving image file generation processing in the multi-hash format is different from the moving image file generation processing in the second shooting mode illustrated in FIG. 9 in steps S905 and S915 to S918.

In step S905, the control unit 102 inputs the encoded data stored in the mdat box on the RAM 103 in step S904 to the hashing unit 107, and instructs the hashing unit 107 to acquire a hash value. The multi-hash format is a format in which a hash value is obtained for each unit called a chunk of the mdat box. The hashing unit 107 acquires a hash value for each chunk, and records the acquired hash value in a uuid box different from the moov box, the mdat box, and the manifest store box. The uuid box that stores the hash value for each chunk is described as a Merkle store box. Note that, in the moving image file generation processing in the multi-hash format, the control unit 102 may acquire the hash value excluding the information regarding the size, or may acquire the hash value including the information regarding the size.

In step S915, the control unit 102 instructs the hashing unit 107 to acquire the hash value of the moov box input in step S914. The control unit 102 acquires the hash value of the moov box acquired by the hashing unit 107.

In step S916, the control unit 102 instructs the data processing unit 106 to update the manifest store box 1013. The data processing unit 106 updates the manifest store box 1013 on the RAM 103. The exclusions 407 used in the second shooting mode does not need to be used in generating the moving image file in the multi-hash format.

In step S917, the control unit 102 records a manifest store box 1302 and a Merkle store box 1305 storing the hash value for each chunk acquired in step S905 in the recording medium 109.

In step S918, the control unit 102 generates one moving image file 1300 by connecting the respective boxes recorded in the recording medium 109. The control unit 102 connects the respective boxes in the order of an ftype box 1301, the manifest store box 1302, a moov box 1303, an mdat box 1304, and the Merkle store box 1305. FIG. 13 illustrates a state of the recording medium 109 after steps S900 to S918 in the moving image file generation processing in the multi-hash format are completed.

In the single hash format, in step S905, the control unit 102 holds the moving image data stored in the mdat box as acquisition data used to acquire the hash value for the moving image file for each predetermined data amount during shooting of the moving image data. When shooting is stopped, in step S914, the control unit 102 adds the management information stored in the moov box to the acquisition data. In step S915, the control unit 102 acquires the hash value for the moving image file as information for proving authenticity of the moving image file by using the acquisition data to which the management information is added.

According to the second embodiment described above, a moving image file generated in the first shooting mode in which shooting is performed for a moving image, the authenticity of which does not need to be proved, can be reproduced by a conventional device. Furthermore, in the second shooting mode in which shooting is performed for a moving image, the authenticity of which is provable, the control unit 102 generates the moving image file in the single hash format or the multi-hash format.

In the single hash format, the control unit 102 generates the moving image file such that the mdat box is arranged before the moov box. In the single hash format, the control unit 102 acquires one hash value for the moving image file. Since the size of the moov box is not determined until shooting is completed, the moov box is arranged after the mdat box so as to be read after the mdat box. By arranging the mdat box before the moov box, the control unit 102 can sequentially start calculation of the hash value from the acquired moving image data even during shooting of the moving image.

In the multi-hash format, the control unit 102 acquires a hash value for each predetermined data amount. The control unit 102 can acquire the hash value for each predetermined data amount of the moving image data without waiting until the size of the moov box is determined. Therefore, in the moving image file in the multi-hash format, the moov box may be arranged before the mdat box. In addition, since the control unit 102 acquires the hash value for each predetermined data amount, it is possible to calculate a hash during shooting of the moving image.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to efficiently acquire information for proving authenticity while suppressing an influence on reproduction and editing processing in a conventional device.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-038251, filed March 11, 2025, which is hereby incorporated by reference herein in its entirety.

What is claimed is:

1. An information processing apparatus comprising:
a processor; and
a memory storing a program which, when executed by the processor, causes the information processing apparatus to:
execute generation processing of generating a moving image file which includes a first area storing therein captured moving image data, and a second area storing therein management information for managing the moving image data; and
execute setting processing of setting any one of a first shooting mode, in which the moving image file is generated without adding information for proving authenticity of the moving image file, and a second shooting mode, in which the moving image file is generated by adding the information for proving the authenticity of the moving image file to the moving image file,
wherein, in the generation processing, arrangement of the first area and the second area in the moving image file is changed based on the shooting mode set in the setting processing.

2. The information processing apparatus according to claim 1, wherein, in the generation processing,
in the first shooting mode, the moving image file is generated such that the second area is arranged before the first area; and
in the second shooting mode, the moving image file is generated such that the first area is arranged before the second area.

3. The information processing apparatus according to claim 1, wherein, in the generation processing, in a case where the shooting mode is set to the second shooting mode,
during shooting of the moving image data, the moving image data to be stored in the first area is held for each predetermined data amount as acquisition data used to acquire a hash value for the moving image file;
when the shooting is stopped, the management information to be stored in the second area is added to the acquisition data; and
by using the acquisition data having the management information added thereto, the hash value for the moving image file is acquired as the information for proving the authenticity of the moving image file.

4. The information processing apparatus according to claim 1, wherein
in the setting processing, in a case where the shooting mode is set to the second shooting mode, it is selected whether to acquire the information for proving the authenticity of the moving image file by a first acquisition method or a second acquisition method different from the first acquisition method, and
in the generation processing, the arrangement of the first area and the second area in the moving image file is changed based on the acquisition method selected in the setting processing.

5. The information processing apparatus according to claim 4, wherein
a hash value for the moving image file is acquired in the first acquisition method, and
in a case where the first acquisition method is selected in the setting processing, the moving image file is generated in the generation processing such that the first area is arranged before the second area.

6. The information processing apparatus according to claim 5, wherein, in the generation processing, in a case where the first acquisition method is selected in the setting processing,
during shooting of the moving image data, the moving image data to be stored in the first area is held for each predetermined data amount as acquisition data used to acquire the hash value for the moving image file;
when the shooting is stopped, the management information to be stored in the second area is added to the acquisition data; and
by using the acquisition data having the management information added thereto, the hash value for the moving image file is acquired as the information for proving the authenticity of the moving image file.

7. The information processing apparatus according to claim 5, wherein
the hash value is acquired for each predetermined data amount of the moving image file in the second acquisition method, and
in a case where the second acquisition method is selected in the setting processing, the moving image file is generated in the generation processing such that the second area is arranged before the first area.

8. The information processing apparatus according to claim 1, wherein
in the generation processing, the information for proving the authenticity of the moving image file is acquired by excluding, from among the moving image data, information regarding a size of the moving image data.

9. The information processing apparatus according to claim 1, wherein
the information for proving the authenticity of the moving image file is stored in an area other than the first area and the second area of the moving image file.

10. An information processing method comprising:
generating a moving image file which includes a first area storing therein captured moving image data, and a second area storing therein management information for managing the moving image data; and
setting any one of a first shooting mode, in which the moving image file is generated without adding information for proving authenticity of the moving image file, and a second shooting mode, in which the moving image file is generated by adding the information for proving the authenticity of the moving image file to the moving image file,
wherein, in the generating, arrangement of the first area and the second area in the moving image file is changed based on the shooting mode set in the setting.

11. A non-transitory computer readable medium that stores a program, wherein the program causes a computer to execute an information processing method comprising:
generating a moving image file which includes a first area storing therein captured moving image data, and a second area storing therein management information for managing the moving image data; and
setting any one of a first shooting mode, in which the moving image file is generated without adding information for proving authenticity of the moving image file, and a second shooting mode, in which the moving image file is generated by adding the information for proving the authenticity of the moving image file to the moving image file,
wherein, in the generating, arrangement of the first area and the second area in the moving image file is changed based on the shooting mode set in the setting.
